(19) United States
(12) Patent Application Publication
(10) Pub. No.: US 2023/0242364 A1
(43) Pub. Date: Aug. 3, 2023

(54) ADHESIVE TAPE PASTING DEVICE, MECHANISM AND METHOD FOR ZERO-TENSION DOUBLE-FACED ADHESIVE TAPE PASTING

(71) Applicant: JIANGSU KATOP AUTOMATION CO., LTD., Jiangsu (CN)

(72) Inventor: Zhenhua FAN, Jiangsu (CN)

(21) Appl. No.: 18/011,088

(22) PCT Filed: Dec. 2, 2020
(86) PCT No.: PCT/CN2020/133460

§ 371 Date: Dec. 16, 2022

(30) Foreign Application Priority Data
Jun. 18, 2020 (CN) 202010559504.2

(51) Int. Cl. B65H 18/10; B65H 23/185; B65H 23/198; B65H 35/06; B65H 37/04

(52) U.S. Cl. CPC B65H 18/103; B65H 23/185; B65H 23/198; B65H 35/06; B65H 37/04; B65H 2301/51532; B65H 2701/3772

(57) ABSTRACT

Provided are an adhesive tape pasting device, mechanism and method for zero-tension double-faced adhesive tape pasting, which belong to foil adhesive tape pasting apparatuses. The adhesive tape pasting device comprises an unwinding station, a winding station, a winding electric motor and an adhesive tape pasting assembly, where after the unwinding station unwinds a double-faced adhesive tape and the adhesive tape pasting assembly pastes an adhesive tape of the double-faced adhesive tape onto a foil, the winding electric motor drives the winding station to wind a remaining release paper of the double-faced adhesive tape. The adhesive tape pasting device further comprises an unwinding driving assembly, where the unwinding driving assembly drives the unwinding station to carry out unwinding work, and in the adhesive tape pasting process, the unwinding work and winding work are carried out synchronously.

### TECHNICAL FIELD

The present disclosure relates to foil adhesive tape pasting apparatuses and, in particular to an adhesive tape pasting device, mechanism and method for zero-tension double-faced adhesive tape pasting.

### BACKGROUND

The existing Chinese Patent Application Publication No. CN111113930A provides a clutch-type multifunctional adhesive tape pasting mechanism for synchronous punching, adhesive tape pasting and cutting, which achieves the automatic integration functions of punching, adhesive tape pasting and cutting in the tape slicing and tape-preparation for narrow and wide foils.

In the preceding technology, a winding station actively winds a release paper, and with a tractive force of a double-faced adhesive tape to an unwinding station, the double-faced adhesive tape is continuously unwound from the unwinding station. Since the double-faced adhesive tape is pasted on a foil under a certain tractive force, the double-faced adhesive tape rebounds and shrinks after the adhesive tape is pasted and left to stand for a period of time, causing the problem that the foil wrinkles and has a poor appearance. Therefore, the preceding technology needs to be improved.

### SUMMARY

To overcome deficiencies in the existing art, the present disclosure provides an adhesive tape pasting device, mechanism and method for zero-tension double-faced adhesive tape pasting to solve the preceding technical problems.

To solve the preceding technical problems, the present disclosure adopts the technical solutions described below.

An adhesive tape pasting device for zero-tension double-faced adhesive tape pasting is provided. The adhesive tape pasting device includes an unwinding station, a winding station, a winding electric motor and an adhesive tape pasting assembly. After the unwinding station unwinds a double-faced adhesive tape and the adhesive tape pasting assembly pastes an adhesive tape of the double-faced adhesive tape onto a foil, the winding electric motor drives the winding station to wind a remaining release paper of the double-faced adhesive tape.

The adhesive tape pasting device further includes an unwinding driving assembly. The unwinding driving assembly drives the unwinding station to carry out unwinding work, and in the adhesive tape pasting process, the unwinding work and winding work are carried out synchronously.

Through the preceding technical solution, in the adhesive tape pasting process, the unwinding station carries out the active unwinding work, the winding station carries out the active winding work, and the unwinding driving assembly and the winding electric motor are set to keep the linear speed at which the unwinding station rotates and the linear speed at which the winding station rotates consistent, thereby ensuring that the double-faced adhesive tape is pasted on the foil under the condition of no tractive force.

In the present disclosure, an independent power source is provided for the unwinding station so that no tractive force is applied to the double-faced adhesive tape, thereby avoiding the problem that the foil wrinkles and has a poor appearance due to the rebound and shrinkage of the double-faced adhesive tape.

In an exemplary embodiment, the adhesive tape pasting device further includes a cutter assembly for cutting the adhesive tape after the adhesive tape pasting is completed. The cutter assembly includes a cutter and a driving cylinder for driving the cutter to carry out a cut-down operation, and the surface of the cutter is configured as a bending surface with multiple sharp points.

Through the preceding technical solutions, the cutter assembly is controlled to move upward or downward through the propulsion and reset of the driving cylinder so that the cutter assembly can complete the adhesive tape cutting work; in addition, the junction of the bending surface of the cutter transitions is a form of fold lines so that the junction is sharper, and when the cutter cuts the adhesive tape, the adhesive tape is torn off at the junction, thereby more quickly completing the adhesive tape cutting work.

In an exemplary embodiment, the unwinding driving assembly includes an unwinding electric motor for driving the unwinding station to rotate and a brake member.

Through the preceding technical solutions, the unwinding electric motor is used for driving the unwinding station to rotate, and the brake member can stop at the winding station after the cutter assembly completes the adhesive tape cutting work, thereby preventing the double-faced adhesive tape from being excessively wound into the unwinding station.

In an exemplary embodiment, the adhesive tape pasting assembly includes a first adhesive tape pasting guide roller, a second adhesive tape pasting guide roller and an adhesive tape pasting head. The double-faced adhesive tape is unwound through the unwinding station and then guided to a position below the adhesive tape pasting head through the first adhesive tape pasting guide roller and the second adhesive tape pasting guide roller sequentially, and the adhesive tape pasting head pastes the adhesive tape of the double-faced adhesive tape onto the foil.

Through the preceding technical solutions, both the first adhesive tape pasting guide roller and the second adhesive tape pasting guide roller play a guiding role so that the double-faced adhesive tape can be placed under the adhesive tape pasting head at a preset position and at a preset angle and the adhesive tape pasting head rolls on the foil and presses the adhesive tape down on the foil.

In an exemplary embodiment, the adhesive tape pasting device further includes a flat pressing sheet for pre-flattening on the foil.

Through the preceding technical solutions, the flat pressing sheet is usually disposed in front of the moving direction of the adhesive tape pasting head so that the foil can be pressed down to be flat by the flat pressing sheet before being pasted, thereby resulting in a better adhesive tape pasting effect and avoiding the problem that the foil wrinkles after the adhesive tape pasting.

An adhesive tape pasting mechanism for zero-tension double-faced adhesive tape pasting is provided. The adhesive tape pasting mechanism includes a control unit, a linear module, and the adhesive tape pasting device according to any of the preceding technical solutions.

Through the preceding technical solution, the rotational speed of the unwinding electric motor and the rotational speed of the winding electric motor are controlled through the control unit, and the unwinding electric motor and the winding electric motor adopt different torques in the adhesive tape pasting preparation process, the adhesive tape opening process, the adhesive tape pasting process and the adhesive tape cutting process to ensure that the unwinding station and the winding station have the same linear speed in the adhesive tape pasting process so that the adhesive tape can be pasted on the foil with zero tension.

An adhesive tape pasting method for zero-tension double-faced adhesive tape pasting is provided. The adhesive tape pasting method includes an adhesive tape pasting preparation process S1, an adhesive tape opening process S2, an adhesive tape pasting process S3, and an adhesive tape cutting process S4.

In the adhesive tape pasting preparation process S1, an unwinding electric motor drives an unwinding station to unwind, a winding electric motor drives a winding station to wind, the difference between the torque of the unwinding electric motor and the torque of the winding electric motor is controlled to be less than a systemic resistance, and after a double-faced adhesive tape is tightened, the torque of the unwinding electric motor and the torque of the winding electric motor are gradually lowered to enable the double-faced adhesive tape to be in a zero-tension state.

In the adhesive tape opening process S2, the torque of the winding electric motor is set to an adhesive tape opening winding torque, the torque of the unwinding electric motor is set to an adhesive tape opening unwinding torque, the winding electric motor drives the winding station to unwind, the unwinding electric motor drives the unwinding station to unwind, and the winding station and the unwinding station accelerate to a preset speed at the same acceleration.

In the adhesive tape pasting process S3, a linear module drives an adhesive tape pasting device to move on a foil at a linear speed to carry out adhesive tape pasting work, where in the adhesive tape pasting process, the linear speed of the unwinding station and the linear speed of the winding station are a preset speed which is the same as the linear speed of the linear module.

In the adhesive tape cutting process S4, the linear module, the unwinding station and the winding station decelerate at the same deceleration to rest, a cutter cuts an adhesive tape, and at the same time when the cutter cuts the adhesive tape, the unwinding electric motor drives the unwinding station to unwind at a torque which is not less than a cutting torque, where the cutting torque is the minimum torque at which the double-faced adhesive tape is not pulled out.

In an exemplary embodiment, in S1, a method for measuring the systemic resistance is: the same initial torque is set for the winding electric motor and the unwinding electric motor when the adhesive tape pasting device is in a static state, the winding electric motor drives the winding station to wind, the unwinding electric motor drives the unwinding station to unwind, the torque of the winding electric motor or the torque of the unwinding electric motor is gradually increased until the double-faced adhesive tape is pulled, a current unwinding torque of the unwinding electric motor and a current winding torque of the winding electric motor are recorded, and the difference between the unwinding torque and the winding torque is taken as the systemic resistance.

In an exemplary embodiment, in S2, a method for measuring the adhesive tape opening winding torque and the adhesive tape opening unwinding torque is: an initial winding torque is set for the winding electric motor and an initial unwinding torque is set for the unwinding electric motor when the adhesive tape pasting device is in a static state, the winding electric motor drives the winding station to wind, the unwinding electric motor drives the unwinding station to unwind, a relationship curve between the linear speed of the winding station and time and a relationship curve between the linear speed of the unwinding station and time are measured through a speed measuring tool, the initial winding torque and the initial unwinding torque are adjusted until the relationship curve between the linear speed of the winding station and the time is the same as the relationship curve between the linear speed of the unwinding station and the time, a current winding torque is recorded as the adhesive tape opening winding torque, and a current unwinding torque is recorded as the adhesive tape opening unwinding torque.

In an exemplary embodiment, in S4, a method for measuring the cutting torque is: an initial torque is set for the unwinding electric motor, the unwinding station is driven to wind, if the double-faced adhesive tape is not pulled back by the cutter when the cutter cuts the adhesive tape, the initial torque is gradually lowered until the double-faced adhesive tape is pulled back by the cutter when the cutter cuts the adhesive tape, and a current torque of the unwinding electric motor is recorded as the cutting torque.

The present disclosure has beneficial effects described below.

1. In the present disclosure, an independent power source is provided for the unwinding station so that no tractive force is applied to the double-faced adhesive tape, thereby avoiding the problem that the foil wrinkles and has a poor appearance due to the rebound and shrinkage of the double-faced adhesive tape.

2. The junction of the bending surface of the cutter transitions is a form of fold lines so that the junction is sharper, and when the cutter cuts the adhesive tape, the adhesive tape is torn off at the junction, thereby more quickly completing the adhesive tape cutting work.

3. The brake member can stop at the winding station after the cutter assembly completes the adhesive tape cutting work, thereby preventing the double-faced adhesive tape from being excessively wound into the unwinding station.

4. The flat pressing sheet is usually disposed in front of the moving direction of the adhesive tape pasting head so that the foil can be pressed down to be flat by the flat pressing sheet before being pasted, thereby resulting in a better adhesive tape pasting effect and avoiding the problem that the foil wrinkles after the adhesive tape pasting.

5. The unwinding station and the winding station pull back the double-faced adhesive tape simultaneously before the adhesive tape pasting so that the double-faced adhesive tape is in a relatively tight state; otherwise, the double-faced adhesive tape is pasted on the foil in a relaxed state, causing the adhesive tape pasted on the foil to wrinkle.

### BRIEF DESCRIPTION OF DRAWINGS

The present disclosure is further described below in conjunction with drawings and embodiments.

FIG. 1 is a structure view of an adhesive tape pasting device according to the present disclosure; and

FIG. 2 is a flowchart of the subdivision of working conditions of an adhesive tape pasting method according to the present disclosure.

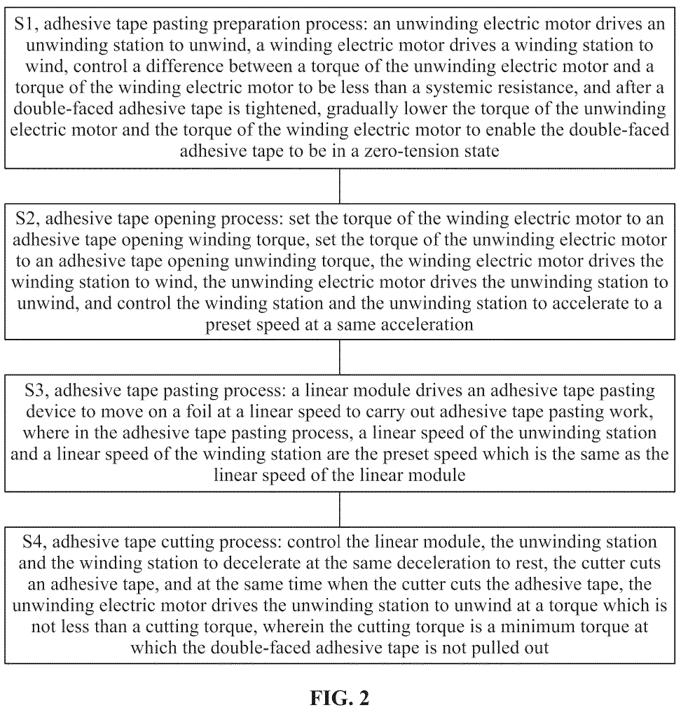

Reference list

| | |
|---|---|
| 1 | unwinding station |
| 2 | unwinding driving assembly |
| 201 | unwinding electric motor |
| 202 | brake member |
| 3 | winding station |
| 4 | winding electric motor |
| 5 | cutter assembly |
| 501 | cutter |
| 502 | driving cylinder |
| 6 | adhesive tape pasting assembly |
| 601 | first adhesive tape pasting guide roller |
| 602 | second adhesive tape pasting guide roller |
| 603 | adhesive tape pasting head |
| 7 | flat pressing sheet |

### DETAILED DESCRIPTION

To provide a fuller understanding of objects, features and advantages of the present disclosure, a clear and complete description of the concept, specific structures and produced technical effects of the present disclosure will be given below in conjunction with the drawings and embodiments. Apparently, the embodiments described below are part, not all, of the embodiments of the present disclosure. Based on the embodiments of the present disclosure, all other embodiments obtained by those skilled in the art without creative work are within the scope of the present disclosure. In addition, all coupling/connection relationships involved in the patent do not just refer to the direct connection of components, but to the better coupling structures formed by adding or reducing coupling accessories according to the specific implementation. If not in collision, various technical features of the present disclosure can be combined interactively.

For the ordinary adhesive tape pasting device, the winding station works actively while the unwinding station works passively, and when the winding station winds the double-faced adhesive tape, a tension is generated on the unwinding station so that the double-faced adhesive tape is continuously released from the unwinding station. Since the double-faced adhesive tape is pasted on a foil under a certain tractive force, the double-faced adhesive tape rebounds and shrinks after the adhesive tape is pasted and left to stand for a period of time, causing the problem that the foil wrinkles and has a poor appearance.

To solve the preceding problems, the present disclosure provides an adhesive tape pasting device, mechanism and method for zero-tension double-faced adhesive tape pasting.

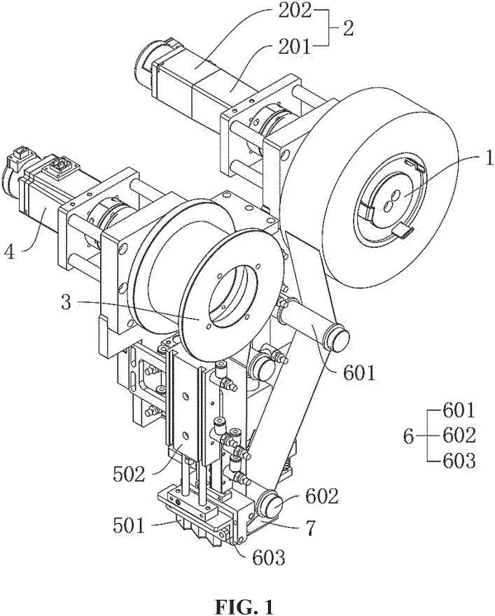

As shown in FIG. 1, the adhesive tape pasting device for zero-tension double-faced adhesive tape pasting includes an unwinding station 1, a winding station 3, a winding electric motor 4 and an adhesive tape pasting assembly 6. After the unwinding station 1 unwinds a double-faced adhesive tape and the adhesive tape pasting assembly 6 pastes an adhesive tape of the double-faced adhesive tape onto a foil, the winding electric motor 4 drives the winding station 3 to wind the remaining release paper of the double-faced adhesive tape.

The double-faced adhesive tape includes a release paper and an adhesive tape, the winding electric motor 4 can adopt a conventional winding electric motor 4, and any winding electric motor that can drive the winding station 3 to rotate may be taken as the winding electric motor 4 herein.

The adhesive tape pasting device further includes an unwinding driving assembly 2. The unwinding driving assembly 2 drives the unwinding station 1 to carry out unwinding work, and in the adhesive tape pasting process, the unwinding work and winding work are carried out synchronously.

In the adhesive tape pasting process, the unwinding station 1 carries out the active unwinding work, the winding station 3 carries out the active winding work, and the unwinding driving assembly 2 and the winding electric motor 4 are set to keep the linear speed at which the unwinding station 1 rotates and the linear speed at which the winding station 3 rotates consistent, thereby ensuring that the double-faced adhesive tape is pasted on the foil under the condition of no tractive force.

In the present disclosure, an independent power source is provided for the unwinding station 1 so that no tractive force is applied to the double-faced adhesive tape, thereby avoiding the problem that the foil wrinkles and has a poor appearance due to the rebound and shrinkage of the double-faced adhesive tape.

The adhesive tape pasting device further includes a cutter assembly 5 for cutting the adhesive tape after the adhesive tape pasting is completed. The cutter assembly 5 includes a cutter 501 and a driving cylinder 502 for driving the cutter 501 to carry out a cut-down operation, and the cutter assembly 5 is controlled to move upward or downward through the propulsion and reset of the driving cylinder 502 so that the cutter assembly 5 can complete the adhesive tape cutting work.

The surface of the cutter 501 is configured as a bending surface with multiple sharp points. The junction of the bending surface of the cutter 501 transitions is a form of fold lines so that the junction is sharper, and when the cutter 501 cuts the adhesive tape, the adhesive tape is torn off at the junction, thereby more quickly completing the adhesive tape cutting work.

The unwinding driving assembly 2 includes an unwinding electric motor 201 for driving the unwinding station 1 to rotate and a brake member 202. The unwinding electric motor 201 is used for driving the unwinding station 1 to rotate, and the brake member 202 can stop at the winding station 1 after the cutter assembly 5 completes the adhesive tape cutting work, thereby preventing the double-faced adhesive tape from being excessively wound into the unwinding station 1.

The adhesive tape pasting assembly 6 includes a first adhesive tape pasting guide roller 601, a second adhesive tape pasting guide roller 602 and an adhesive tape pasting head 603. The double-faced adhesive tape is unwound through the unwinding station 1 and then guided to a position below the adhesive tape pasting head 603 through the first adhesive tape pasting guide roller 601 and the second adhesive tape pasting guide roller 602 sequentially, and the adhesive tape pasting head 603 pastes the adhesive tape of the double-faced adhesive tape onto the foil. Both the first adhesive tape pasting guide roller 601 and the second adhesive tape pasting guide roller 602 play a guiding role so that the double-faced adhesive tape can be placed under the adhesive tape pasting head 603 at a preset position and at a preset angle and the adhesive tape pasting head 603 rolls on the foil and presses the adhesive tape down on the foil.

The adhesive tape pasting device further includes a flat pressing sheet 7 for pre-flattening on the foil. The flat pressing sheet 7 is usually disposed in front of the moving direction of the adhesive tape pasting head 603 so that the foil can be pressed down to be flat by the flat pressing sheet 7 before being pasted, thereby resulting in a better adhesive tape pasting effect and avoiding the problem that the foil wrinkles after the adhesive tape pasting.

Before the adhesive tape pasting, the unwinding station 1 and the winding station 3 wind simultaneously to tighten the double-faced adhesive tape. The unwinding station 1 and the winding station 3 pull back the double-faced adhesive tape simultaneously before the adhesive tape pasting so that the double-faced adhesive tape is in a relatively tight state; otherwise, the double-faced adhesive tape is pasted on the foil in a relaxed state, causing the adhesive tape pasted on the foil to wrinkle.

The present disclosure further provides an adhesive tape pasting mechanism for zero-tension double-faced adhesive tape pasting. The adhesive tape pasting mechanism includes a control unit and the preceding adhesive tape pasting device.

The rotational speed of the unwinding electric motor 201 and the rotational speed of the winding electric motor 4 are controlled through the control unit. In various processes such as processes before adhesive tape pasting, at the start of adhesive tape pasting, during adhesive tape pasting and during adhesive tape cutting, the unwinding electric motor 201 and the winding electric motor 4 provide different linear speeds for the unwinding electric motor 201 and the winding electric motor 4, so that the double-faced adhesive tape can be pasted on the foil with zero tension.

To match the preceding adhesive tape pasting device and mechanism for zero-tension double-faced adhesive tape pasting, the present disclosure further provides an adhesive tape pasting method for the adhesive tape pasting device.

The adhesive tape pasting method for zero-tension double-faced adhesive tape pasting includes an adhesive tape pasting preparation process S1, an adhesive tape opening process S2, an adhesive tape pasting process S3, and an adhesive tape cutting process S4.

In the adhesive tape pasting preparation process S1, the unwinding electric motor 201 drives the unwinding station 1 to unwind, the winding electric motor 4 drives the winding station 3 to wind, the difference between the torque of the unwinding electric motor 201 and the torque of the winding electric motor 4 is controlled to be less than a systemic resistance, and after the double-faced adhesive tape is tightened, the torque of the unwinding electric motor 201 and the torque of the winding electric motor 4 are gradually lowered to enable the double-faced adhesive tape to be in a zero-tension state.

The process S1 is mainly to enable the double-faced adhesive tape to be in a zero-tension state before adhesive tape pasting. The zero-tension state in the present disclosure means that the double-faced adhesive tape is gradually tightened from a relaxed state to a state where the double-faced adhesive tape is just ready to have tension, that is, a state where the foil does not wrinkle even after the double-faced adhesive tape is pasted on the foil for a period of time.

In the process S1, a method for measuring the systemic resistance is: the same initial torque is set for the winding electric motor 4 and the unwinding electric motor 201 when the adhesive tape pasting device is in a static state, the winding electric motor 4 drives the winding station 3 to wind, the unwinding electric motor 201 drives the unwinding station 1 to unwind, the torque of the winding electric motor 4 or the torque of the unwinding electric motor 201 is gradually increased until the double-faced adhesive tape is pulled, a current unwinding torque of the unwinding electric motor 201 and a current winding torque of the winding electric motor 4 are recorded, and the difference between the unwinding torque and the winding torque is taken as the systemic resistance.

In the adhesive tape opening process S2, the torque of the winding electric motor 4 is set to an adhesive tape opening winding torque, the torque of the unwinding electric motor 201 is set to an adhesive tape opening unwinding torque, the winding electric motor 4 drives the winding station 3 to unwind, the unwinding electric motor 201 drives the unwinding station 1 to unwind, and the winding station 3 and the unwinding station 1 accelerate to a preset speed at the same acceleration.

The process S2 is mainly to ensure that no tension is applied to the double-faced adhesive tape in the process where the linear speed of the winding station 3 and the linear speed of the unwinding station 1 accelerate to the preset speed.

In the process S2, a method for measuring the adhesive tape opening winding torque and the adhesive tape opening unwinding torque is: an initial winding torque is set for the winding electric motor 4 and an initial unwinding torque is set for the unwinding electric motor 201 when the adhesive tape pasting device is in a static state, the winding electric motor 4 drives the winding station 3 to wind, the unwinding electric motor 201 drives the unwinding station 1 to unwind, a relationship curve between the linear speed of the winding station 3 and time and a relationship curve between the linear speed of the unwinding station 1 and time are measured through a speed measuring tool, the initial winding torque and the initial unwinding torque are adjusted until the relationship curve between the linear speed of the winding station 3 and the time is the same as the relationship curve between the linear speed of the unwinding station 1 and the time, a current winding torque is recorded as the adhesive tape opening winding torque, and a current unwinding torque is recorded as the adhesive tape opening unwinding torque.

In the adhesive tape pasting process S3, the linear module drives an adhesive tape pasting device to move on a foil at a linear speed to carry out adhesive tape pasting work, where in the adhesive tape pasting process, the linear speed of the unwinding station 1 and the linear speed of the winding station 3 are a preset speed which is the same as the linear speed of the linear module.

The linear speed is the speed at which the adhesive tape pasting head moves relative to the foil and is also the speed at which the linear module is driven.

In the adhesive tape cutting process S4, the linear module, the unwinding station 1 and the winding station 3 decelerate at the same deceleration to rest, the cutter 501 cuts the adhesive tape, at the same time when the cutter 501 cuts the adhesive tape, the unwinding electric motor 201 drives the unwinding station 1 to unwind at a torque which is not less than a cutting torque, where the cutting torque is the minimum torque at which the double-faced adhesive tape is not pulled out, the cutter 501 is restored after the cutter 501 cuts the adhesive tape, and the brake 202 stops the winding electric motor 201.

In the process S4, a method for measuring the cutting torque is: an initial torque is set for the unwinding electric motor 201, the unwinding station 1 is driven to wind, if the double-faced adhesive tape is not pulled back by the cutter 501 when the cutter 501 cuts the adhesive tape, the initial torque is gradually lowered until the double-faced adhesive tape is pulled back by the cutter 501 when the cutter 501 cuts the adhesive tape, and a current torque of the unwinding electric motor 201 is recorded as the cutting torque.

The preceding is the specific description of preferred embodiments of the present disclosure. However, the present disclosure is not limited to the preceding embodiments. Various equivalent modifications or substitutions may be made by those skilled in the art without departing from the spirit of the present disclosure. These equivalent modifications or substitutions fall within the scope of the claims in the present application.

What is claimed is:

1. An adhesive tape pasting device for zero-tension double-faced adhesive tape pasting, comprising an unwinding station, a winding station, a winding electric motor and an adhesive tape pasting assembly, wherein after the unwinding station unwinds a double-faced adhesive tape and the adhesive tape pasting assembly pastes an adhesive tape of the double-faced adhesive tape onto a foil, the winding electric motor drives the winding station to wind a remaining release paper of the double-faced adhesive tape; and
further comprising an unwinding driving assembly, wherein the unwinding driving assembly drives the unwinding station to carry out unwinding work, and in an adhesive tape pasting process, the unwinding work and winding work are carried out synchronously.

2. The adhesive tape pasting device for zero-tension double-faced adhesive tape pasting according to claim 1, further comprising a cutter assembly for cutting the adhesive tape after adhesive tape pasting is completed, wherein the cutter assembly comprises a cutter and a driving cylinder for driving the cutter to carry out a cut-down operation, and a surface of the cutter is configured as a bending surface with a plurality of sharp points.

3. The adhesive tape pasting device for zero-tension double-faced adhesive tape pasting according to claim 1, wherein the unwinding driving assembly comprises an unwinding electric motor for driving the unwinding station to rotate and a brake member.

4. The adhesive tape pasting device for zero-tension double-faced adhesive tape pasting according to claim 1, wherein the adhesive tape pasting assembly comprises a first adhesive tape pasting guide roller, a second adhesive tape pasting guide roller and an adhesive tape pasting head, the double-faced adhesive tape is unwound through the unwinding station and then guided to a position below the adhesive tape pasting head through the first adhesive tape pasting guide roller and the second adhesive tape pasting guide roller sequentially, and the adhesive tape pasting head pastes the adhesive tape of the double-faced adhesive tape onto the foil.

5. The adhesive tape pasting device for zero-tension double-faced adhesive tape pasting according to claim 1, further comprising a flat pressing sheet for pre-flattening the foil.

6. An adhesive tape pasting mechanism for zero-tension double-faced adhesive tape pasting, comprising a control unit, a linear module, and an adhesive tape pasting device;
wherein the adhesive tape pasting device comprises an unwinding station, a winding station, a winding electric motor and an adhesive tape pasting assembly, wherein after the unwinding station unwinds a double-faced adhesive tape and the adhesive tape pasting assembly pastes an adhesive tape of the double-faced adhesive tape onto a foil, the winding electric motor drives the winding station to wind a remaining release paper of the double-faced adhesive tape; and
the adhesive tape pasting device further comprises an unwinding driving assembly, wherein the unwinding driving assembly drives the unwinding station to carry out unwinding work, and in an adhesive tape pasting process, the unwinding work and winding work are carried out synchronously.

7. An adhesive tape pasting method for zero-tension double-faced adhesive tape pasting, comprising an adhesive tape pasting preparation process S1, an adhesive tape opening process S2, an adhesive tape pasting process S3, and an adhesive tape cutting process S4;
S1, the adhesive tape pasting preparation process: driving, by an unwinding electric motor, an unwinding station to unwind, driving, by a winding electric motor, a winding station to wind, controlling a difference between a torque of the unwinding electric motor and a torque of the winding electric motor to be less than a systemic resistance, and after a double-faced adhesive tape is tightened, gradually lowering the torque of the unwinding electric motor and the torque of the winding electric motor to enable the double-faced adhesive tape to be in a zero-tension state;
S2, the adhesive tape opening process: setting the torque of the winding electric motor to an adhesive tape opening winding torque, setting the torque of the unwinding electric motor to an adhesive tape opening unwinding torque, driving, by the winding electric motor, the winding station to wind, driving, by the unwinding electric motor, the unwinding station to unwind, and controlling the winding station and the unwinding station to accelerate to a preset speed at a same acceleration;
S3, the adhesive tape pasting process: driving, by a linear module, an adhesive tape pasting device to move on a foil at a linear speed to carry out adhesive tape pasting work, wherein in the adhesive tape pasting process, a linear speed of the unwinding station and a linear speed of the winding station are the preset speed which is the same as the linear speed of the linear module; and
S4, the adhesive tape cutting process: controlling the linear module, the unwinding station and the winding station to decelerate at a same deceleration to rest, cutting, by a cutter, an adhesive tape, and at the same time when the cutter cuts the adhesive tape, driving, by the unwinding electric motor, the unwinding station to unwind at a torque which is not less than a cutting torque, wherein the cutting torque is a minimum torque at which the double-faced adhesive tape is not pulled out.

8. The adhesive tape pasting method for zero-tension double-faced adhesive tape pasting according to claim 7, wherein in S1, a method for measuring the systemic resistance is: setting a same initial torque for the winding electric motor and the unwinding electric motor when the adhesive tape pasting device is in a static state, driving, by the winding electric motor, the winding station to wind, driving, by the unwinding electric motor, the unwinding station to unwind, gradually increasing the torque of the unwinding electric motor or the torque of the winding electric motor until the double-faced adhesive tape is pulled, recording a current unwinding torque of the unwinding electric motor and a current winding torque of the winding electric motor, and taking a difference between the unwinding torque and the winding torque as the systemic resistance.

9. The adhesive tape pasting method for zero-tension double-faced adhesive tape pasting according to claim 7, wherein in S2, a method for measuring the adhesive tape opening winding torque and the adhesive tape opening unwinding torque is: setting an initial winding torque for the winding electric motor and an initial unwinding torque for the unwinding electric motor when the adhesive tape pasting device is in a static state, driving, by the winding electric motor, the winding station to wind, driving, by the unwinding electric motor, the unwinding station to unwind, measuring a relationship curve between the linear speed of the winding station and time and a relationship curve between the linear speed of the unwinding station and time through a speed measuring tool, adjusting the initial winding torque and the initial unwinding torque until the relationship curve between the linear speed of the winding station and the time is the same as the relationship curve between the linear speed of the unwinding station and the time, and recording a current winding torque as the adhesive tape opening winding torque and a current unwinding torque as the adhesive tape opening unwinding torque.

10. The adhesive tape pasting method for zero-tension double-faced adhesive tape pasting according to claim 7, wherein in S4, a method for measuring the cutting torque is: setting an initial torque for the unwinding electric motor, driving the unwinding station to wind, if the double-faced adhesive tape is not pulled back by the cutter when the cutter cuts the adhesive tape, gradually lowering the initial torque until the double-faced adhesive tape is pulled back by the cutter when the cutter cuts the adhesive tape, and recording a current torque of the unwinding electric motor as the cutting torque.

11. The adhesive tape pasting mechanism for zero-tension double-faced adhesive tape pasting according to claim 6, wherein the adhesive tape pasting device for zero-tension double-faced adhesive tape pasting further comprise a cutter assembly for cutting the adhesive tape after adhesive tape pasting is completed, wherein the cutter assembly comprises a cutter and a driving cylinder for driving the cutter to carry out a cut-down operation, and a surface of the cutter is configured as a bending surface with a plurality of sharp points.

12. The adhesive tape pasting mechanism for zero-tension double-faced adhesive tape pasting according to claim 6, wherein the unwinding driving assembly comprises an unwinding electric motor for driving the unwinding station to rotate and a brake member.

13. The adhesive tape pasting mechanism for zero-tension double-faced adhesive tape pasting according to claim 6, wherein the adhesive tape pasting assembly comprises a first adhesive tape pasting guide roller, a second adhesive tape pasting guide roller and an adhesive tape pasting head, the double-faced adhesive tape is unwound through the unwinding station and then guided to a position below the adhesive tape pasting head through the first adhesive tape pasting guide roller and the second adhesive tape pasting guide roller sequentially, and the adhesive tape pasting head pastes the adhesive tape of the double-faced adhesive tape onto the foil.

14. The adhesive tape pasting mechanism for zero-tension double-faced adhesive tape pasting according to claim 6, wherein the adhesive tape pasting device for zero-tension double-faced adhesive tape pasting further comprise a flat pressing sheet for pre-flattening the foil.
